(19) United States
(12) Patent Application Publication
(10) Pub. No.: US 2006/0027945 A1
(43) Pub. Date: Feb. 9, 2006

(54) Process and apparatus for the production of BCF yarns

(75) Inventors: Arnd Grimm, Westerronfeld (DE); Joachim Brenk, Armstedt (DE); Holger Brandt, Ehndorf (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Saurer GmbH & Co. KG

(21) Appl. No.: 11/242,181

(22) Filed: Oct. 3, 2005

Related U.S. Application Data
(63) Continuation of application No. PCT/EP04/03454, filed on Apr. 1, 2004.

(30) Foreign Application Priority Data
Apr. 3, 2003 (DE) 103 15 130.3

(51) Int. Cl. B29C 47/88

(52) U.S. Cl. 264/211.14; 264/211.22; 425/72.2

(57) ABSTRACT

A process and apparatus for producing BCF yarns, in which a plurality of strand-like filaments are extruded, cooled, and combined into several yarns. The filaments are extruded in the form of a downwardly advancing annular filament sheet, and the filaments in the sheet are cooled by directing a cool air flow radially through the annular sheet. The sheet is divided into segments and the filaments of each segment are gathered to form a multifilament yarn, and each yarn can then be drawn and bulked, and finally wound into a package.

### CROSS REFERENCE TO RELATED APPLICATION

The present application is a continuation of international application PCT/EP2004/003454, filed Apr. 1, 2004, and which designates the U.S. The disclosure of the referenced application is incorporated herein by reference.

### BACKGROUND OF THE INVENTION

The present invention relates to a process for the production of BCF yarns as well as a apparatus for the production of BCF yarns.

The production of so-called BCF (bulked continuous filament) yarns is accomplished in a one-step spinning process, and the resulting melt-spun and bulked BCF yarns are used mainly for carpet yarns. In the spinning process, a plurality of strand-like filaments are extruded, cooled, and consolidated into a bundle to form a yarn, which is then drawn, bulked, and wound into a package. The filament strands consolidated to form the yarn are extruded in the form of a bundle by means of a spinneret which comprises on its underside one nozzle hole for each of the filaments. Thus, several filament bundles are extruded by several spinnerets. In order to produce several yarns in parallel side by side in spinning processes of this type, basically two system concepts are known.

EP 0 363 317 A2 and corresponding U.S. Pat. No. 5,059,104 disclose a process and a apparatus in which each of the filament bundles forming a yarn is extruded by one spinneret. The spinnerets are disposed side by side to form an annular arrangement so that the individual filament bundles are fed, in an annular arrangement, to a cooling zone. The cooling is done by a cool air flow produced from the inside outward. After the cooling the filament bundles are consolidated to form the yarns, and subsequently drawn, textured, and wound into packages.

Different from this, a second system concept for the production of BCF yarns also follows from EP 0 363 317 A2. In this known process and the known apparatus the filament strands forming a yarn are extruded by means of a spinneret. For the production of several yarns the spinnerets are disposed side by side in a row arrangement so that for the production of several yarns the spinning apparatus requires a correspondingly large space.

The processes and apparatus known in the state of the art have, in principle, the disadvantage that the filament strands are extruded in the form of a bundle so that to form yarns with relatively large total titer a high filament density is reached during the extrusion, which does not ensure a uniform cooling of all the filament strands. The bundle-like arrangement of the filaments during the extrusion has in addition the disadvantage that a cool air flow directed from outside onto the bundle of filament strands leads to the filament strands experiencing a lower cooling in the interior of the bundle than the filament strands which are fed at the outer edge of the bundle. In the production of BCF yarns the requirement of uniformity is particularly high since further processing is not provided. Particular importance falls to the cooling because the physical characteristics of the filaments are directly affected thereby.

It is an object of the invention to provide a process and an apparatus for the production of BCF yarns in which the filaments consolidated to form yarns have a high uniformity in quality.

It is an additional object of the invention to provide a process and an apparatus of the type mentioned initially with which BCF yarns can be produced with a high melt throughput and high filament density.

It is also an object of the invention to provide a process and an apparatus for the production of BCF yarns of the generic type in which a flexible division of the filament strands to form several yarns is possible.

### SUMMARY OF THE INVENTION

The above and other objects and advantages of the present invention are achieved by the provision of a process and apparatus wherein a downwardly advancing annular filament sheet is extruded, and the advancing filament sheet is cooled by directing a cool air flow from the inside of the annular sheet outward through the sheet. Also, the annular filament sheet is divided into segments which are each gathered to form a multifilament yarn. Thereafter, each of the yarns is drawn and bulked, and then wound into a package.

The invention turns away completely from the known system concepts in which the division of the filaments to form the yarns is done during the extrusion. The invention is based on the fact that a division of the filament strands to form the yarns is only necessary after the extrusion. In particular, the invention combines into a single process the extrusion and the cooling of the plurality of the filaments which form several yarns.

The particular advantage of the invention is given by the fact that each of the filaments fed within the filament sheet can be cooled uniformly. Here the conditions for extrusion and cooling of the filaments are unaffected by the subsequently formed total titer of the individual yarns. Thus, for example, the number of filaments per yarn can be increased by a larger segment of the annular filament sheet being consolidated.

The invention was also not obvious due to the fact that in the state of the art spinning apparatus for the production of staple fibers are known, e.g. from EP 1 247 883 A2 and corresponding U.S. Publ. No. 2002145219, in which a filament sheet arranged as a ring is extruded and consolidated to form a spinning cable. Processes and apparatus of this type are designed to cool, extrude, cool, and consolidate a plurality of filaments. In so doing, preferably several annular filament sheets are connected to form a total tow. However, processes and apparatus of this type are completely unsuitable to produce several separately fed and treated yarns.

For the extrusion of the annular filament sheet forming the BCF yarns the so-called ring spinneret is particularly advantageously suited. Ring spinnerets of this type have on their underside a plurality of nozzle holes which are formed in an annular arrangement. The nozzle holes are disposed, preferably symmetrically, in several rows of holes formed to be concentric to one another. With this, in particular, relatively large filter surfaces can be realized which make possible a high throughput per ring spinneret, specifically more than 150 kg/h.

In order to be able to carry out, in a simple manner, the division of the filament sheet after the cooling, the embodiment of the invention is particularly advantageous in which the annular filament sheet is extruded by several segments of the rings of holes, said segments forming the annular arrangement of nozzle holes of the ring spinneret, and in which the portion of the filament sheet extruded by one of the segments of the rings of holes is consolidated to form one of the yarns. With that, it can advantageously be ensured that each of the yarns has the same number of filaments.

To produce monocolor BCF yarns the ring spinneret's segments of the rings of holes are provided with a polymer melt by a common diffuser chamber. Along with this, additional diffuser or filter elements can be disposed before a nozzle plate containing the nozzle hole.

In another embodiment of the invention, several separate diffuser chambers are formed within the ring spinneret which are each connected to a segment of a ring of holes, or a group of segments of the rings of holes, and through which several polymer melts are diffused to their assigned segments of the rings of holes. This is particularly suitable for producing multicolor BCF yarns. For this, several polymer melts are fed for extrusion of the filament sheet, via the diffuser chamber, to their assigned segment of a ring of holes of the ring spinneret and extruded.

For obtaining a uniform cooling of all the filaments fed in the filament sheet along the entire circumferential surface of the annular filament sheet, the cool air produced by a blowing plug has shown itself to be particularly effective. Through the gas-permeable jacket of the blowing plug a uniform cool air flow is produced in a plurality of radial directions. Here, zones of different gas permeability can be formed on the jacket of the blowing plug in order to produce different cooling zones for cooling or certain blowing profiles of the cool air.

An additional, a particularly advantageous embodiment of the invention is provided by the filament sheet receiving a preparation before the division to form the yarns. Through the annular arrangement of the filament sheet, a uniform application to all the filaments can be produced by external or internal preparation rings.

To divide the filament sheet fed as a ring, the dividing apparatus can be formed below the cooling zone by several yarn feeders which are disposed at intervals on a diffuser ring corresponding to the segment-like division of the filament sheet. Here the diffuser ring can be disposed within the filament sheet or outside of the filament sheet.

A particularly advantageous embodiment of the invention is given by the division of the yarn feeders of the dividing apparatus in a plane. With this, the extension of the yarns can be followed immediately by drawing, bulking, and winding. With the process according to the invention and the apparatus according to the invention, BCF yarns of the most varied type as well as of different yarn material, such as, for example, polyamide, polypropylene, or polyester, can be produced.

The process according to the invention is described in the following with reference to several exemplary embodiments of the apparatus according to the invention and with reference to the accompanying drawings.

### BRIEF DESCRIPTION OF THE DRAWINGS

In the drawings:

FIG. 1 schematically illustrates the structure of a first embodiment of the apparatus according to the invention,

FIG. 2.1 schematically illustrates the underside of an embodiment of a ring spinneret which could be used with the apparatus of FIG. 1,

FIG. 2.2 is a fragmentary cross sectional view of the ring spinneret of FIG. 2.1,

FIG. 3 schematically illustrates an additional embodiment of the apparatus according to the invention,

FIG. 4 schematically illustrates the underside of the ring spinneret from the embodiment according to FIG. 3,

FIG. 5 schematically illustrates an additional embodiment of an apparatus according to the invention, and

FIG. 6 schematically illustrates the structure of an embodiment of a dividing apparatus in accordance with the present invention.

### DETAILED DESCRIPTION OF THE PREFERRED EMBODIMENTS

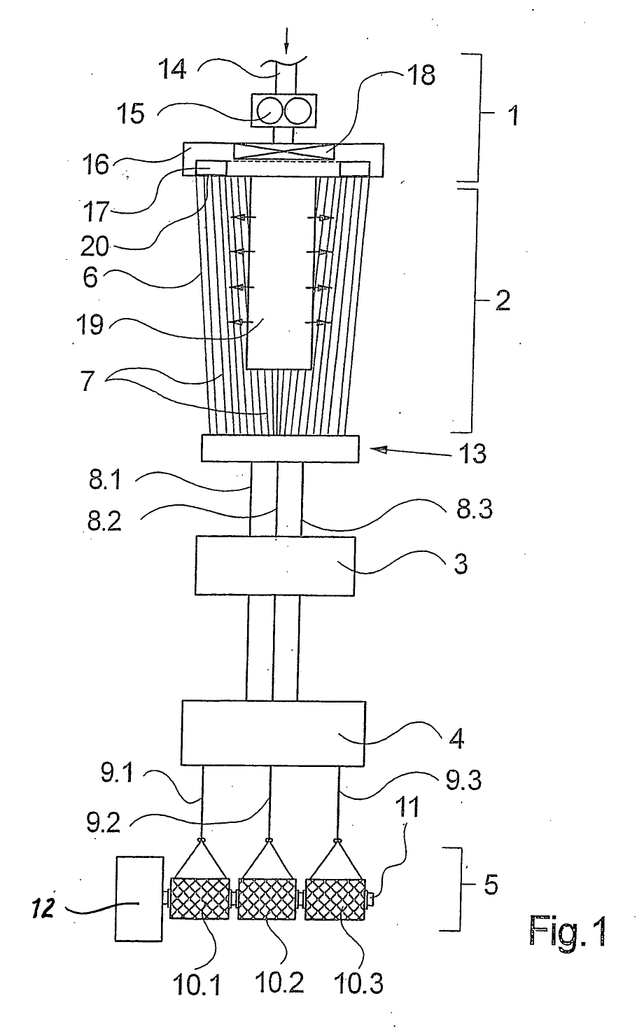

In FIG. 1 the structure of an embodiment of the apparatus according to the invention and for carrying out the process according to the invention is shown in schematic form. The embodiment is composed of a spinning apparatus 1, a cooling apparatus 2, a dividing apparatus 13, a stretching or drawing apparatus 3, a bulking apparatus 4, and a winding apparatus 5 which are arranged to form a yarn path.

The spinning apparatus 1 comprises a nozzle holder 16 which on its underside comprises a ring spinneret 17 acting as nozzle means. The ring spinneret 17 is connected, via a melt diffuser 18, to a spinning pump 15. The spinning pump 15 receives, via a melt intake 14, a melted polymer material. The heating and melting of the polymer material is done preferably by an extruder which is not represented here. The spinning pump 15 can be formed as a single pump or as multiple pumps.

The ring spinneret 17 comprises on its underside an annular nozzle plate 20 which contains a plurality of nozzle holes. Within the nozzle plate 20 the nozzle holes are preferably formed in several consecutively disposed concentric rows of holes.

Below the spinning apparatus 1 the cooling apparatus 2 is disposed, which comprises a blowing means 19 held in the center relative to the ring spinneret 17, e.g. a blowing cylinder with an air-permeable wall. The blowing means 19 is connected, via an air intake not represented here, to a cooling air source so that on the circumferential face of the cylindrical blowing means 19 a cool air flow exiting in the radial direction is produced.

Between the cooling apparatus 2 and the winding apparatus 5 a dividing apparatus 13 for dividing a filament sheet into several yarns, a drawing apparatus 3 for drawing or stretching the yarns, and a bulking apparatus 4 for bulking the yarns are disposed consecutively in the yarn path. The means used within the dividing apparatus 13, the drawing apparatus 3, and the bulking apparatus 4 to feed and/or treat the yarns is not shown in more detail at this point. In principle, any of the known means can be used which can execute the functions assigned to the apparatus.

Also represented only in schematic form is the winding apparatus 5, which includes a projecting spindle 11 which is held and driven by a spindle bearing 12. On the spindle 11, three yarn packages 10.1, 10.2, and 10.3 are wound side by side. Winding machines of this type for winding BCF yarns are preferably formed by machines which comprise two spool spindles which are held on a movable bearing in such a manner that a continuous winding of the yarns is possible by changing the relative positions of the spool spindles. Other conventional components of the winding apparatus, such as a package changing apparatus and a pressure roll, are not represented here. A winding machine of this type is known, for example, from WO 96/01222 so that at this point reference is made to this publication.

In the embodiment of FIG. 1, for the production of a total of three BCF yarns, first a polymer melt, e.g. of polyamide or polypropylene, in the spinning apparatus 1 is fed through the spinning pump 15 and to the ring spinneret 17. In so doing, the polymer melt is held under a melt pressure so that strand-like filaments 6 are extruded from the nozzle holes of the ring spinneret 17. The plurality of filaments 6 exiting from the nozzle holes of the ring spinneret 17 form an annular filament sheet 7. The filament sheet 7 is drawn off from the spinning apparatus 1 by the drawing apparatus 3 or by an additional draw-off element disposed in between.

Below the spinning apparatus 1 a cool air flow is produced by the blowing means 19 of the cooling apparatus 2, said cool air flow penetrating the annular veil of the filament sheet 7 uniformly. Thereby a cooling occurs and thus a solidification of the individual filaments 6 of the annular filament sheet 7. After the filaments 6 are solidified, the filament sheet 7 arrives at the dividing apparatus 13. Here a segment-like division of the annular filament sheet 7 into several yarns takes place. In the embodiment of FIG. 1, the filament sheet 7 is divided into three yarns 8.1, 8.2, and 8.3. Each of the yarns 8.1, 8.2, and 8.3 is subsequently drawn by the drawing apparatus 3. For this, roller systems are preferably used which stretch the yarns in parallel and in common. However, it is also possible to draw each of the yarns 8.1 to 8.3 separately.

After the drawing, the yarns 8.1 to 8.3 are bulked in the bulking apparatus 4. In order to obtain typical bulking for the BCF yarns, the bulking apparatus preferably comprises several texturing nozzles which compress each of the yarns 8.1 to 8.3 by a hot air flow to form a yarn plug which is fed after actuation of the winding apparatus 5. In the winding apparatus 5 each of the bulked yarns is wound to form a package 10.1, 10.2, and 10.3.

The BCF yarns produced with the process according to the invention are distinguished by a particularly high uniformity of the characteristics of the individual filaments. The uniform characteristics of the filaments cause in addition a uniform bulking so that, along with the physical characteristics, the visual characteristics of these BCF yarns also have a particularly advantageous appearance.

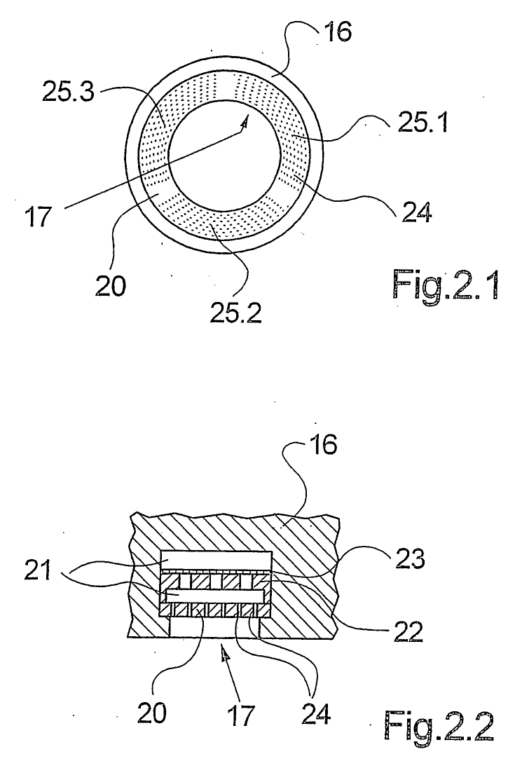

In FIG. 2.1 an embodiment of the ring spinneret 17 is shown, as it would be possible to use, for example, in the embodiment according to FIG. 1. FIG. 2.1 is a view of the underside of a ring spinneret and FIG. 2.2 a partial cross section of the ring spinneret. In so far as no express reference to one of the figures is made, the following description applies to both figures.

The ring spinneret 17 is held by a nozzle holder 16. The nozzle holder 16 can, for example, be held on a spinning beam which comprises several nozzle holders side by side. The ring spinneret 17 comprises on the underside a nozzle plate 20 which contains a plurality of nozzle holes 24. The nozzle plate 20 is formed as a ring. The plurality of nozzle holes 24 are divided in the nozzle plate 20 into three groups, each of which forms a segment 25.1, 25.2, and 25.3 of the rings of holes. The segments 25.1, 25.2, and 25.3 of the rings of holes have identical forms. Between the segments 25.1, 25.2, and 25.3 of the rings of holes partial sections are formed in the nozzle plate 20 which contain no nozzle holes. Thus, small gaps are formed during the extrusion of the annular filament sheet which are used to divide the annular filament sheet. With this, a precise division of the entire filament sheet is made possible in a simple manner.

As represented in FIG. 2.2, in the ring spinneret 17 a diffuser chamber 21 is disposed above the nozzle plate 20, the diffuser chamber also being formed as a ring. Within the diffuser chamber 21 a perforated plate 22 and a filter insert 23 are disposed above the nozzle plate 20 so that the polymer melt passing through the nozzle holes 24 of the nozzle plate 20 has been filtered previously through the filter insert 23. The diffuser chamber 21 extends within the ring spinneret 17 in the form of a ring above the nozzle plate 20.

The diffuser chamber 21 is, as represented in FIG. 1, connected, via a melt diffuser 18, to the spinning pump 15. Here the melt diffuser 18 could be formed by a line system which contains several melt lines emptying into the diffuser chamber 21. Via the diffuser chamber 21 the polymer melt is diffused uniformly in the ring spinneret 17 and extruded by the segments of the rings of holes of the nozzle plate to form the annular filament sheet. Ring spinnerets of this type are thus advantageous for producing BCF yarns from a polymer melt which is not dyed, or dyed with a certain dye.

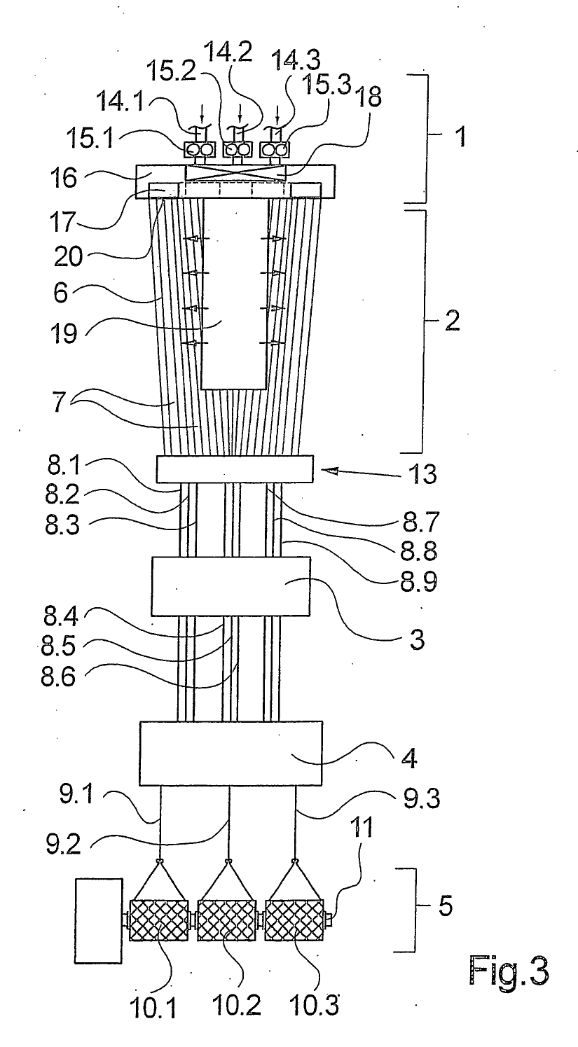

In FIG. 3 an additional embodiment of the apparatus according to the invention for carrying out the process according to the invention is represented in a basic schematic form. The basic structure of the embodiment according to FIG. 3 is essentially identical to the foregoing embodiment of the apparatus according to the invention so that reference is made to the foregoing description and at this point only the differences will be pointed out.

The embodiment of FIG. 3 is composed of a spinning apparatus 1, a cooling apparatus 2, a dividing apparatus 13, a drawing apparatus 3, a bulking apparatus 4, and a winding apparatus 5. The spinning apparatus 1 comprises three separate spinning pumps 15.1, 15.2, and 15.3. Each of the pumps 15.1, 15.2, and 15.3 is connected, via a melt intake 14.1, 14.2, and 14.3 to separate melt sources. Each of the melt sources, preferably extruders, produce polymer melts which are different in their properties, composition, or type. Thus, for example, three differently dyed polymer melts could be fed to the individual spinning pumps 15.1, 15.2, and 15.3. However, it is also possible to connect all the spinning pumps to one melt source in order, for example, to produce several monocolor yarns in parallel.

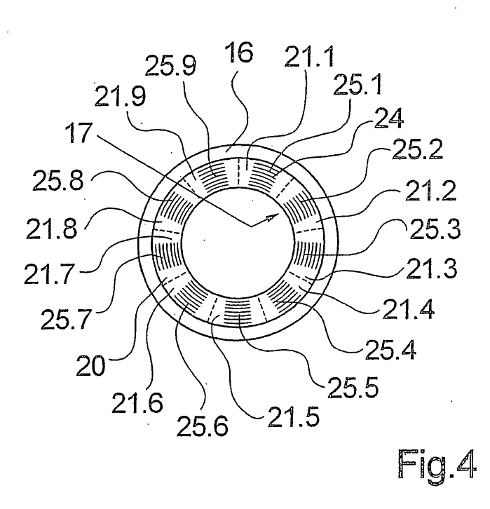

For extruding the three different polymer melts to form a filament sheet, the ring spinneret 17 is divided on the underside of the nozzle holder 16 into several segments of rings of holes with associated separate diffuser chambers. In FIG. 4, a view of the ring spinneret 17 is represented. The nozzle plate 20 of the ring spinneret 17 comprises a total of nine segments 25.1 to 25.9 of rings of holes formed side by side, said segments each containing a plurality of nozzle holes 24. Intervals are formed between the nozzle holes 24 of the segments 25.1 to 25.9 of rings of holes. To each of the segments 25.1 to 25.9 of rings of holes a separate diffuser chamber 21.1 to 21.9 is assigned.

The separation of each of the diffuser chambers 21.1 to 21.9 is formed by a separating wall which is represented as a dashed line in FIG. 4. The diffuser chambers 21.1 to 21.9 are connected via a melt diffuser 18 (FIG. 3) to the three spinning pumps 15.1, 15.2, and 15.3. Here the segments 25.1 to 25.9 of rings of holes form a total of three groups in which the three differently dyed polymer melts are extruded side by side as a segment-like filament sheet. For this, for example, the spinning pump 15.1 could be connected, via the melt diffuser 18, to the diffuser chambers 21.1, 21.4, and 21.7. The spinning pump 15.2 could be connected, via the melt diffuser 18, to the diffuser chambers 21.2, 21.5, and 21.8, and the spinning pump 15.3 could be connected, via the melt diffuser 18, to the diffuser chambers 21.3, 21.6, and 21.9. Assigned to the diffuser chambers 21.1 to 21.9, the segments 25.1 to 25.9 of rings of holes accordingly extrude the different polymers in three groups with the same assignment.

The extruded filaments 6 of all the segments 25.1 to 25.9 of rings of holes are drawn off from the spinning apparatus 1 in common in an annular arrangement as filament sheet 7. Along with this, a cool air flow produced by a blowing means 19 is blown from the inside outwards through the filament sheet 7. After the solidification of the individual filaments of the filament sheet 7, the filaments which were extruded from a segment 25.1 to 25.9 of rings of holes are consolidated, via the dividing apparatus 13, to form a yarn. Thus a total of nine yarns 8.1 to 8.9 running in parallel are formed from the annular filament sheet 7.

The yarns 8.1 to 8.9 are drawn in parallel side by side by the stretching apparatus 3 and fed into the bulking apparatus 4. Within the bulking apparatus 4, three yarns extruded from different polymer melts are consolidated to form one composite yarn. Thus, three bulked composite yarns 9.1 to 9.3 are formed from the yarns 8.1 to 8.9. For this, for example, all three yarns can be compressed together via a texturing nozzle to form a yarn plug. The yarn plug is then subsequently undone to form a composite yarn. A bulking apparatus of this type is known, for example, from DE 197 46 878 A1. There is however also the possibility of bulking the yarns separately so that the bulked individual yarns are consolidated, e.g. by an intermingling apparatus, to form a composite yarn, as is known from EP 1 035 238 A1.

Each of the composite yarns 9.1, 9.2, and 9.3 is subsequently wound into a package 10.1, 10.2, and 10.3.

Represented in FIG. 3, the embodiment of the apparatus according to the invention is suitable in particular for applying the process according to the invention to the production of so-called tricolor yarns.

In the embodiments represented in FIG. 1 and FIG. 3 the cooling apparatus is formed by a cylindrical blowing means 19 which produces a radial flow of blown air. The cool air can be fed via the nozzle holder or via the opposite end of the blowing means. The blowing wall facing the filament sheet could, for example, be formed of a hollow, cylindrical, seamless, perforated metal sheet. Particularly advantageous is the formation of the blowing means as a blowing plug which comprises a porous jacket of a non-woven, foam, sieve fabric, or a sintered material. A blowing plug of this type is known, for example, from EP 1 231 302 A1. Cooling apparatus of this type are distinguished by the fact that a radial cool air flow is produced which is very uniform over the entire circumferential surface of the blowing plug.

Furthermore, it is to be noted that the components in the embodiments according to FIGS. 1 and 3 are exemplary in the structure of the spinning apparatus. Thus, for a spinneret subdivided into several segments and having several diffuser chambers, one spinning pump could be assigned to each of the diffuser chambers so that one spinning pump is assigned to each yarn.

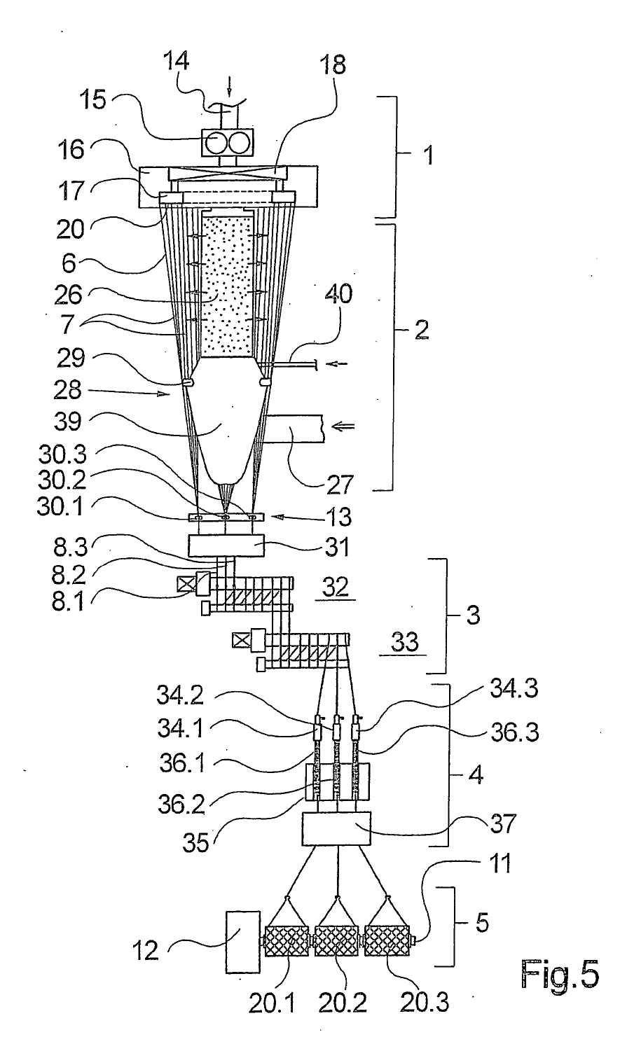

In FIG. 5, represented in schematic form, is an additional embodiment of the apparatus according to the invention, in which apparatus the known blowing plug is used. For the description of the blowing plug reference is made at this point to EP 1 231 302 A1.

In the illustrated embodiment the blowing plug 26 is held by its upper end on the nozzle holder 16. At the opposite end of the blowing plug 26 the air intake 27 is positioned. Here a cool air flow is conducted into the interior of the blowing plug 26 via a holding apparatus 39. On the circumferential surface of the holding apparatus 39 a preparation apparatus 28 is provided. The preparation apparatus 28 comprises an encircling preparation ring 29 which is attached to a preparation intake 40. The preparation ring 29 comprises on its surface a preparation means, where the filament sheet 7 produced by the ring spinneret 17 is fed into contact with the preparation ring 29. Due to this there is a uniform preparation of the individual filaments 6. To extrude the filament sheet 7 the spinning apparatus 1 may have a structure identical to the embodiment example according to FIG. 1. To that extent reference is made to the description relating to FIG. 1.

To divide the annular filament sheet 7 a dividing apparatus 13 is disposed below the cooling apparatus 2, the dividing apparatus being formed by several yarn feeders 30.1, 30.2, and 30.3 disposed, in a plane of the yarn path, side by side at a distance from one another. The filament sheet 7 is divided by the yarn feeders 30.1, 30.2, and 30.3 into three yarns 8.1, 8.2, and 8.3. The yarns 8.1, 8.2, and 8.3 are fed in parallel to a pretreatment apparatus 31. The pretreatment apparatus 31 could comprise one or more processing units in order, for example, to carry out a drawing off, an intermingling, or an additional preparation on the yarns 8.1 to 8.3. Thus, the pretreatment apparatus 31 preferably comprises a godet with a roller in order to draw the yarn sheet or the filament sheet off from the spinning apparatus.

After the pretreatment in the pretreatment apparatus 31 there is a drawing of the yarns 8.1 to 8.3 fed in parallel side by side. For this, two godet units 32 and 33 are disposed consecutively for a stretching apparatus 3. The godet units 32 and 33 are each formed from a driven godet and a roller or of two driven godets. For drawing the yarn the godet units 32 and 33 are driven at a predefined differential speed so that the yarns 8.1 to 8.3 acquire a predefined drawing.

After the drawing, the yarns 8.1 to 8.3 are treated by the bulking apparatus 4 so that each forms a bulked yarn. For this, the bulking apparatus 4 comprises three texturing nozzles 34.1, 34.2, and 34.3 disposed side by side. Each of the texturing nozzles 34.1 to 34.3 has the same structure and each is connected to a compressed air source. Within the texturing nozzles 34.1 to 34.3 the yarns 8.1 to 8.3 are each consolidated to form a yarn plug 36.1 to 36.3. To convey and consolidate the yarns a hot medium is preferably used so that the yarn plugs 36.1 to 36.3 are stored for cooling on a subsequently disposed cooling drum 35 of the bulking apparatus 4. A bulking apparatus of this type is, for example, known from EP 1 146 151 A2 so that reference is made thereto for a more detailed description.

The yarn plugs 36.1, 36.2, and 36.3 are each undone after the cooling to form a bulked yarn, drawn off by the subsequent treatment apparatus 37, and fed to the winding apparatus 5. The subsequent treatment apparatus 37 could also contain several units for subsequent treatment of the yarns such as, for example, intermingling apparatus, godets, and/or preparation apparatus. Depending on the type of the BCF yarn to be produced, different pretreatments in the pretreatment apparatus 31 and different subsequent treatments in the subsequent treatment apparatus 37 can thus be carried out. The BCF yarns are subsequently wound into the packages 10.1 to 10.3.

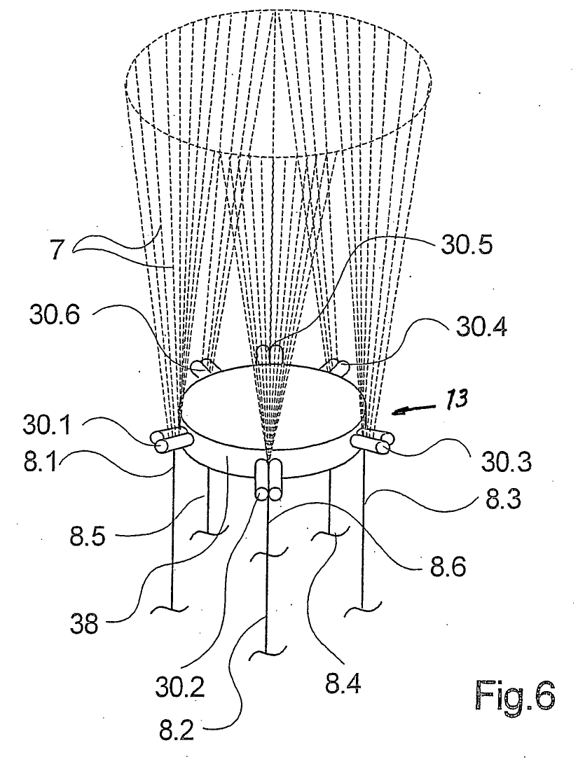

In the embodiment of the invention represented in FIG. 5, the filament sheet 7 fed as a ring is divided to form several yarns fed in a plane of the yarn path. However, there is, in principle, the possibility of first dividing the annular filament sheet into an annular fed yarn sheet. For this, an embodiment of a dividing apparatus 13 is shown in FIG. 6. The dividing apparatus 13 is formed by a diffuser ring 38, to which several yarn feeders disposed at a distance from one another are fastened. The diffuser ring 38 comprises in total 6 yarn feeders 30.1 to 30.6. Thus the annular filament sheet 7 can be divided into six individual yarns 8.1 to 8.6. Particularly advantageous is a division of this type in which the yarns are treated individually in parallel side by side. However, it is also possible to feed the yarns after their division into a yarn path plane aligned in an arbitrary manner to the spinning apparatus.

The embodiments according to FIGS. 1, 3, and 5, of the apparatus according to the invention and the process according to the invention are distinguished in particular by a high performance in the production of qualitatively high-value BCF yarns. Thus, large filter surfaces for the realization of high throughputs can be achieved with the ring spinnerets. The preferably essentially closed annular arrangement of the individual extruded filaments to form a filament sheet permits, with a cool air flow directed in the radial direction, a uniform solidification of the filaments so that each of the filaments has essentially the same physical properties. In principle, it can be mentioned at this point that the cool air could also be directed from the outside inward. For this, the blowing means is attached to a suction apparatus.

Through the segment-like division of the filament sheet the number and the type of yarns can be flexibly structured in a simple manner. The process according to the invention is thus suitable for monocolor as well as for multi-color yarns, which can be used in particular for the production of flat structures, preferably carpets.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A process for the production of BCF yarns, comprising the steps of
extruding a plurality of strand-like filaments in the form of a downwardly advancing annular filament sheet,
cooling the downwardly advancing annular filament sheet by directing a cool air flow radially through the annular sheet,
dividing the annular filament sheet into segments and gathering each of the segments to form a multifilament yarn, and
drawing and bulking each of the yarns and winding each of the drawn and bulked yarns into a package.

2. The process of claim 1 wherein the extruding step includes extruding a polymer melt through a ring spinneret which has an annular arrangement of a plurality of nozzle holes.

3. The process of claim 2, wherein the annular arrangement of the nozzle holes of the ring spinneret is divided into several segments, with the portion of the filament sheet extruded by one of the segments of the annular arrangement being consolidated to form one of the yarns in the dividing and gathering steps.

4. The process of claim 3, wherein the step of extruding a polymer melt through a ring spinneret includes feeding the melt via a common diffusion chamber within the ring spinneret to the segments of the annular arrangement of nozzle holes of the ring spinneret.

5. The process of claim 3, wherein the step of extruding a polymer melt through a ring spinneret includes feeding one or more polymer melts via several separate diffuser chambers within the ring spinneret to respective segments of the annular arrangement of nozzle holes of the ring spinneret.

6. The process of claim 1, wherein the cooling step includes positioning a blowing plug with a gas permeable jacket within the annular filament sheet and blowing cool air outwardly through the jacket in a plurality of radial directions.

7. The process of claim 1, wherein the annular filament sheet is brought into contact with a preparation applying device before the dividing and gathering steps.

8. The process of claim 7, wherein the preparation applying device is in the form of a ring which encircles the inside or the outside of the filament sheet.

9. The process of claim 1, wherein before the winding step the yarns are consolidated into groups to form a composite yarn or several composite yarns.

10. An apparatus for the production of BCF yarns, comprising
a melt spinning device which comprises on its underside a nozzle configured for producing a downwardly advancing annular filament sheet,
a cooling device disposed in the interior of the annular filament sheet,
a blowing means for producing a radial cooling air flow from the cooling device,
and a dividing device positioned below the cooling device for dividing the annular filament sheet into segments which are then formed into respective yarns.

11. The apparatus of claim 10, wherein the nozzle comprises a ring spinneret having an annular arrangement of a plurality of nozzle holes.

12. The apparatus of claim 11, wherein the annular arrangement of nozzle holes of the ring spinneret is divided into several segments through which a portion of the filament sheet is extruded, with each portion being coordinated with the dividing means to form one of said yarns.

13. The apparatus of claim 12, wherein the ring spinneret includes an internal diffuser chamber which communicates with all of the segments of the annular arrangement of the nozzle holes.

14. The apparatus of claim 12, wherein the ring spinneret includes several separate internal diffuser chambers, with the separate diffuser chambers being connected to respective segments of the annular arrangement of the nozzle holes, or to a group of segments of the holes, and through which several polymer melts may be diffused into the segments of the holes.

15. The apparatus of claim 10, wherein the blowing means comprises a blowing plug having a gas permeable jacket, with the blowing plug being held concentric to the ring spinneret, and with the blowing plug being connected to an air intake.

16. The apparatus of claim 10, wherein the dividing device comprises diffuser ring having several yarn feeders disposed at intervals about the periphery thereof and corresponding to the segments of the annular filament sheet.

17. The apparatus of claim 10, wherein the dividing device comprises several yarn feeders which are disposed at intervals around the periphery of the annual filament sheet.

18. The apparatus of claim 10, further comprising a preparation device disposed in the yarn path and before the dividing device, with said preparation device comprising a ring disposed within or outside of the annular filament sheet.

19. The apparatus of claim 10, wherein the melt spinning device comprises a spinning pump through which the polymer melt is fed to the nozzle.

20. The apparatus of claim 10, wherein the melt spinning device comprises several spinning pumps through which several polymer melts are fed to the nozzle.
